(19) United States
(12) Patent Application Publication
(10) Pub. No.: US 2014/0328164 A1
(43) Pub. Date: Nov. 6, 2014

(54) METHOD AND APPARATUS FOR PROTECTION SWITCHING IN ROOTED MULTIPOINT (RMP) CONNECTION NETWORKS

(71) Applicant: Electronics and Telecommunications Research Institute, Daejeon (KR)

(72) Inventors: Dae Ub KIM, Daejeon (KR); Jeong Dong RYOO, Daejeon (KR); Tae Sik CHEUNG, Daejeon (KR)

(73) Assignee: Electronics and Telecommunications Research Institute, Daejeon (KR)

(21) Appl. No.: 14/263,256

(22) Filed: Apr. 28, 2014

(30) Foreign Application Priority Data
Apr. 26, 2013 (KR) 10-2013-0046517
Jun. 17, 2013 (KR) 10-2013-0069000
Apr. 3, 2014 (KR) 10-2014-0039930

(51) Int. Cl. H04L 12/24; H04L 12/707

(52) U.S. Cl. CPC H04L 41/0654; H04L 45/22
USPC 370/225

(57) ABSTRACT

A method of operating a root node in a multipoint-connection with a plurality of leaf nodes, the method including transmitting/receiving traffic with the plurality of leaf nodes via a working path, receiving, from a leaf node, a message indicating an occurrence of a failure on a path of the leaf node from among the plurality of leaf nodes, recognizing an occurrence of a local failure on the path connected to the leaf node, and transmitting information about the failure to the leaf node.

### CROSS-REFERENCE TO RELATED APPLICATIONS

This application claims the priority benefit of Korean Patent Application No. 10-2013-0046517, filed on Apr. 26, 2013, and Korean Patent Application No. 10-2013-0069000, filed on Jun. 17, 2013, Korean Patent Application No. 10-2014-0039930, filed on Apr. 3, 2014, in the Korean Intellectual Property Office, the disclosures of which are incorporated herein by reference.

### BACKGROUND

1. Field of the Invention

The present invention relates to a method and apparatus for a protection switching that allows a rapid protection switching to a protection path provided as an alternative when a failure occurs on a working path in a point-to-multipoint connection network, for example, a rooted multipoint (RMP) connection network.

2. Description of the Related Art

Recent forms of packet transport network technology, such as an optical transport network (OTN), Ethernet, and a multiprotocol label switching transport profile (MPLS-TP), include a method of performing a switching state management and a path protection switching using an automatic protection switching (APS) message for a linear protection switching, for example, OTN linear protection defined in Telecommunication Standardization Sector of the International Telecommunications Union (ITU-T) G873.1, Ethernet linear protection defined in ITU-T G.8031, and MPLS-TP linear protection switching defined in Internet Engineering Task Force (IETF) draft draft-zulr-mpls-tp-linear-pmrotection-switching-03.txt and ITU-T G.8131.1, and a method of performing a switching state management and a path protection switching using a protection state coordination (PSC) message defined in IETF request for comments (RFC) 6378 and ITU-T G8131.2.

The protection switching represents a method of rapidly resuming a transmitting of traffic using an alternative path when the transmitting is suspended due to a network failure. In a current linear protection switching, a working path is set not to encounter a protection path for traffic flowing in both directions or a single direction between point-to-point, and the traffic is transmitted through the protection path in an occurrence of a failure in the working path or when instructed by a command of an operator whereas the traffic is normally transmitted through the working path.

A conventional linear protection switching method employs an APS message or a PSC message in order to exchange, amongst a plurality of nodes, information about a state of the plurality of nodes and locations of a selector and a bridge required for a protection switching. As used herein, unless otherwise indicated, the term “messages” refers to an information transmission message to be used for a protection switching.

In most packet transmission networks, the linear protection switching method includes generating a plurality of virtual connection paths between management points, setting two entities of a working path and a protection path as a protection group from among the plurality of virtual connection paths. When a failure occurs on a predetermined connection path in the set protection group, a management end point (MEP) recognizes the failure, and an automatic protection switching process performs a protection switching.

FIG. 1 illustrates an unmodified ITU-T G18031 Ethernet linear protection switching structure. Here, a linear protection switching function is executed by a sub-network connection (SNC) protection switching process, and the SNC protection switching process determines a bridge/selector of a path.

In a rooted multipoint (RMP) connection network, a single failure may concurrently influence a plurality of leaf nodes. When a multipoint-to-point linear protection switching method is used, a protection restoration processing load may increase in a root node as a number of leaf nodes increases, thus failing to achieve a desired restoration time. Accordingly, a method of switching an entire RMP connection network at once may be adopted in order to avoid the protection restoration processing load in the root node being influenced by the increase in the number of leaf nodes.

### SUMMARY

A technical solution of the present invention aims to perform an appropriate protection switching when a network is configured in a form of point-to-multipoint. According to the present exemplary embodiment, there is provided a method and apparatus for protection restoration in a rooted multipoint (RMP) connection network including a plurality of leaf nodes connected to a root node. As used herein, the root node refers to a node logically connected to multiple points in the form of point-to-multipoint for communication.

According to an aspect of the present invention, there is provided a method of operating a root node, the method including receiving, from a first leaf node, a message indicating an occurrence of a failure on a path of the first leaf node from among a plurality of leaf nodes that transmits/receives traffic, recognizing an occurrence of a local failure on the path of the first leaf node, and transmitting information about the failure to the plurality of leaf nodes.

The method of operating the root node may further include transmitting/receiving traffic by switching a working path to a protection path.

The method of operating the root node may further include transmitting a first no request (NR) message to the plurality of leaf nodes, and receiving a second NR message from the plurality of leaf nodes.

The method of operating the root node may further include transmitting a second signal failure (SF) message indicating an occurrence of a failure on the first leaf node to the plurality of leaf nodes, wherein the second SF message is a message that switches the plurality of leaf nodes to a protection path from a working path.

The method of operating the root node may further include receiving a third NR message indicating a clearance of a failure from the first leaf node.

The method of operating the root node may further include determining that the failure is cleared from the first leaf node, and entering a wait to restore (WTR) state.

The method of operating the root node may further include transmitting a WTR message to the plurality of leaf nodes, or switching from the protection path to the working path.

The transmitting of the second SF message may include transmitting the second SF message comprising information indicating that an occurrence of a failure in a root node is fake, and the transmitting of the WTR message comprises transmitting the WTR message comprising information indicating a clearance of a failure in a root node is fake.

The method of operating the root node may further include transmitting the WTR message and initiating a WTR timer, and transmitting a fourth NR message to the plurality of leaf nodes when the WTR timer is suspended.

The fourth NR message may be a message that switches the plurality of leaf nodes to a working path from a protection path.

The method of operating the root node may further include maintaining transmitting/receiving of the traffic to the protection path.

The method of operating the root node may further include transmitting the NR message to the plurality of leaf nodes when an additional request is absent. The method of operating the root node may further include transmitting a do not revert (DNR) message to the plurality of leaf nodes in lieu of transmitting the WTR message in a non-revertive mode.

The method of operating the root node may further include receiving a request including a priority from the plurality of leaf nodes.

The method of operating the root node may further include processing the request from the plurality of leaf nodes based on the priority.

According to an aspect of the present invention, there is provided a method of operating a leaf node, the method including detecting an occurrence of a failure on a working path for transmitting/receiving a root node and traffic, transmitting a first SF message indicating the occurrence of the failure on the working path, receiving a second SF message indicating the occurrence of the failure on the working path, and transmitting/receiving traffic by switching the working path to a protection path.

The method of operating the leaf node may further include detecting that a clearance of the failure, and transmitting, to the root node, a third NR message indicating the clearance of the failure.

The method of operating the leaf node may further include receiving a WTR message from the root node, receiving a fourth NR message indicating the clearance of the failure, and switching the protection path to the working path.

The method of operating the leaf node may further include receiving a DNR message from the root node, receiving the fourth NR message indicating the clearance of the failure, and maintaining transmitting/receiving of traffic to the protection path.

The method of operating the leaf node may further include detecting that a clearance of the failure, and transmitting a WTR message to the plurality of leaf nodes or transmitting a message indicating a switching to a working path from a protection path or transmitting a message indicating that a failure is cleared.

According to the present exemplary embodiment there is provided an apparatus and method of performing a point-to-multipoint protection switching in an occurrence of a failure in a path for transmitting/receiving a packet and a connection node in an RMP connection network.

According to an aspect of the present invention, there is provided a method and apparatus for a protection switching that allows a rapid protection switching to an alternative path a failure occurs on a transmitting/receiving path in a point-to-multipoint connection network, for example, an RMP connection network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an Ethernet linear protection switching structure defined in Telecommunication Standardization Sector of the International Telecommunications Union (ITU-T) G.8031 according to a related art;

FIG. 2 is a diagram illustrating an example of a network configuration to which a protection switching is applied in a rooted multipoint (RMP) connection network according to an embodiment of the present invention;

FIG. 3A is a diagram illustrating an example of an occurrence of a failure on a path to a leaf node from a root node in a network to which a protection switching is applied in an RMP connection path according to an embodiment of the present invention;

FIG. 3B is a block diagram illustrating a node, for example, a root node or a leaf node according to an embodiment of the present invention;

FIGS. 4A and 4B are timing diagrams illustrating an example of a per-tree protection switching process in a 1:1 revertive mode in the failure of FIG. 3A;

FIG. 5 is a timing diagram illustrating a switching process according to another embodiment of the present invention;

FIGS. 6A and 6B are timing diagrams illustrating a per-tree protection switching process in a 1:1 non-revertive-mode according to another embodiment of the present invention;

FIG. 7 is a timing diagram illustrating a switching process according to another embodiment of the present invention;

FIGS. 8A and 8B are timing diagrams illustrating another per-tree protection switching process in a 1:1 revertive mode in the failure of FIG. 3A;

FIGS. 9A and 91 are timing diagrams illustrating another per-tree protection switching process in a 1:1 non-revertive mode in the failure of FIG. 3A;

FIG. 10 is a timing diagram illustrating an example of a protection switching message form according to an embodiment of the present invention; and

FIG. 11 is a diagram illustrating an example of using a fake—(F) or propagation—(P) flag according to embodiments of the present invention.

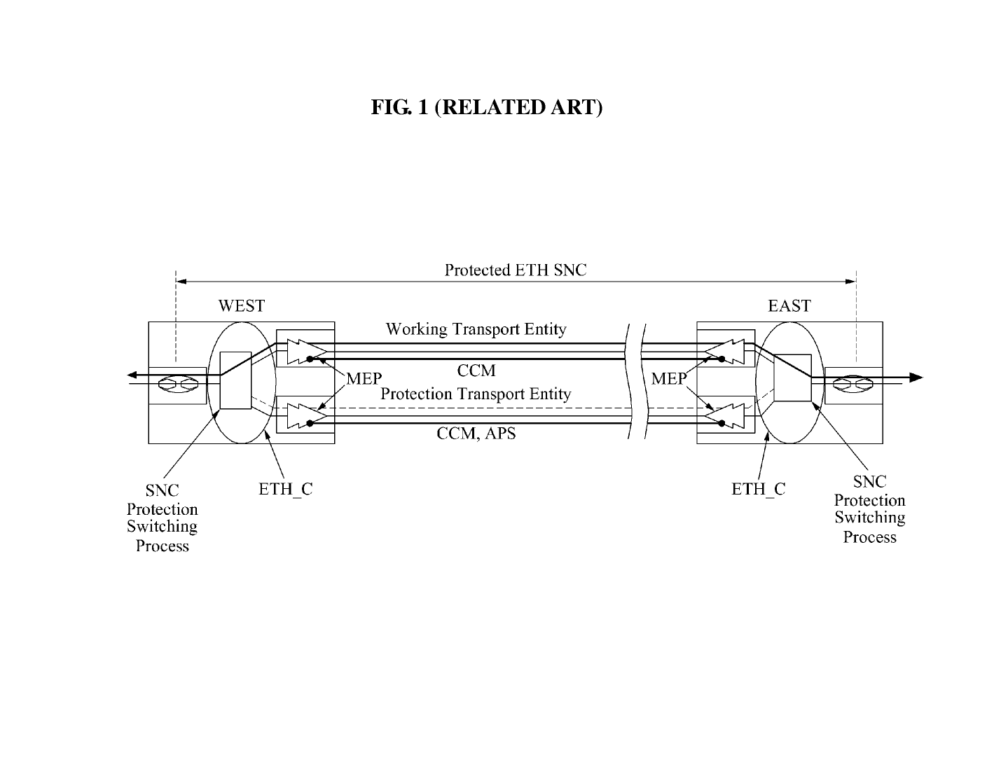

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Is a term that includes ordinal number, such as 1st, 2nd, can be used to describe the various components, but the components by the terms and is not limited The ordinal description is used only to distinguish one component from another. For example, a first element, without departing from the scope of the present invention can be termed a second element, and, similarly, a second element could be termed a first element. As used herein, such terms are used for describing particular embodiments only, and are not intended to limit the present invention. Distinctly different in context, does not mean that a representation of the singular includes multiple representations.

It will be understood that when an element or layer is referred to as being “on” or “connected to” another element or layer, it can be directly on or operatively connected to the other element or layer or through intervening elements or layers may be present. In contrast, when an element is referred to as being “directly on” or “directly connected to” another element or layer, there are no intervening elements or layers present. Like reference numerals refer to like elements throughout. As used herein, the term “and/or” includes any and all combinations of one or more of the associated listed items.

As used herein. “contain” or “combination” terms not listed in the specification, features, integers, steps, operations, elements, components or combinations thereof that may specify one or more components should be understood as being precluded from the features, integers, steps, operations, elements, components, or combinations thereof, or the presence of additional possibilities.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

In addition, as described with reference to the accompanying drawings, the same components and corresponding components are given the same reference number and corresponding drawings numbered duplicate description will be omitted. In describing the present invention, a detailed description of known techniques related to unnecessarily obscure the gist of the present invention, it is determined that the detailed description thereof will be omitted.

The present disclosure is directed to a method and apparatus for protection switching that performs a rapid protection switching to an alternative path in an occurrence of a failure on a packet transmitting/receiving path in a point-to-multipoint.

An aspect of the present invention provides a point-to-multipoint connection network, being a logical network, configured to connect a single root node to a plurality of leaf nodes, and transmit unicast traffic sent from a root node to a predetermined single leaf node, multicast traffic sent from a root node to a plurality of predetermined lead nodes, broadcast traffic sent from a root node to all leaf nodes, and unicast traffic sent from a leaf node to a root node. The network having such characteristics is referred to as an E-Tree defined by Metro Ethernet Forum (MEF) or a rooted multipoint (RMP) connection network defined by the Institute of Electrical and Electronics Engineers (IEEE) and Telecommunication Standardization Sector of the International Telecommunications Union (ITU-T) in accordance with international standards. Also, a service including the aforementioned types of traffic is referred to as an E-Tree service, an RMP connection service, or a point-to-multipoint (p2mp) service. In this instance, the network according to the present disclosure refers to a network for supporting the E-Tree service or the RMP connection service.

Another aspect of the present invention also provides an RMP connection protection switching technology that is applicable to a point-to-multipoint network used in various networks, such as an optical traffic network (OTN), Ethernet, carrier Ethernet, an Ethernet passive optical network (E-PON), a G-PON, provider backbone bridge traffic engineering (PBB-TE), a multiprotocol label switching (MPLS), MPLS-transport profile (TP), or a communication connection between a wireless terminal and an access point.

The terms “a working path and a protection path” as used herein include a transport path through which a packet is transmitted from a start to a destination in an optical transport network, an Ethernet network, a packet network, a packet transport network, and an MPLS label network, a virtual tunnel, an exclusive network, a virtual channel, and a connection, and are hereinafter referred to as a “path” for conciseness and ease of description.

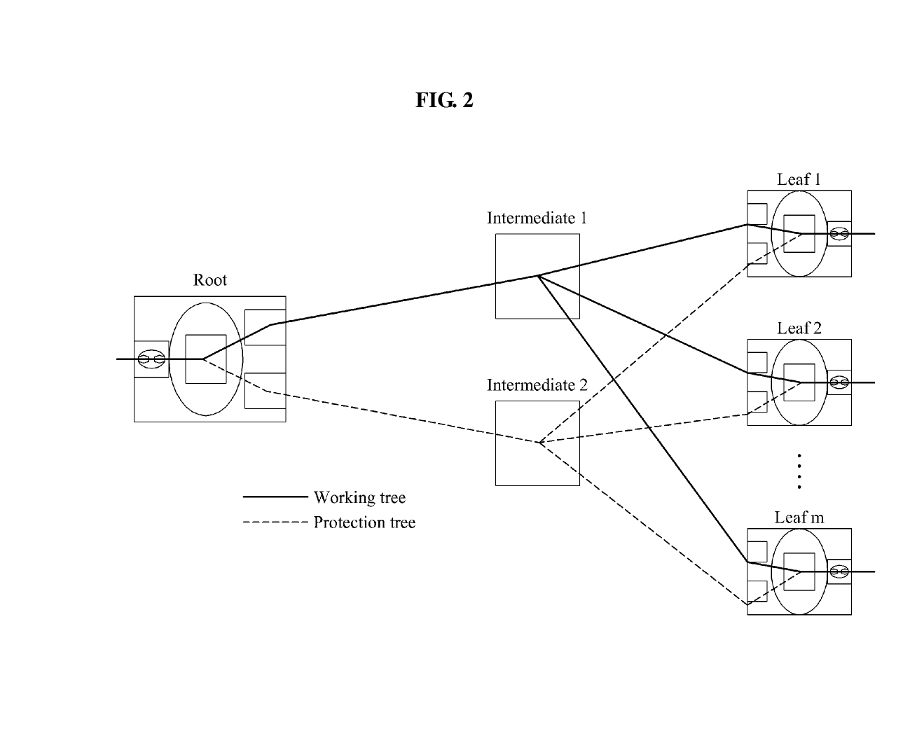

FIG. 2 is a diagram illustrating an example of a network configuration to which a protection switching is applied in an RMP connection network according to an embodiment of the present invention. Referring to FIG. 2, a solid line and a dotted line indicate a bi-directional working tree and a bi-directional protection tree, respectively, between a root node and a plurality of leaf nodes. The root node connects a plurality of paths in a form of a tree to transmit/receive data with the plurality of leaf nodes, for example, Leaf 1 through Leaf m.

In an instance of the working tree, the root node passes through a first intermediate node, for example, Intermediate 1, and is connected to the plurality of leaf nodes, for example, Leaf 1 through Leaf m. In an instance of the protection tree, the root node passes through a second intermediate node, for example, Intermediate 2, and is connected to the plurality of leaf nodes, for example, Leaf 1 through Leaf m.

A point-to-multipoint path in the form of the tree connected as previously described is set and managed as a tree path. Two tree paths including a working tree path and a protection tree path arc required to perform a protection switching. When a failure occurs in one tree path, traffic is rapidly switched to another tree path absent a failure to resume communication.

When a working tree path in a form of a single tree is in a point-to-multipoint connection, unicast communication, multicast communication, and broadcast communication may be available between the root node and the plurality of leaf nodes. A protection tree path to protect the communication is provided in the form of the tree in a manner similar to the working tree path, and an intermediate node between a root node and a leaf node. An intermediate node disposed between the root node and the leaf node sets the working tree path and the protection tree path to be distinguished from each other to be protected in an occurrence of an arbitrary failure, and completes a protection group network tree setting for a protection switching including a pair of the working tree path and the protection tree path. A plurality of nodes on a tree path performs a data copying for multicast communication and broadcast communication. In the working tree path or the protection tree path, a connection from a root node to a leaf node is configured by a point-to-multipoint connection, and a connection in an opposite direction, for example, from a leaf node to a root node, is configured by a multipoint-to-point connection. Also, each tree path may include a combination of the point-to-multipoint connection and the multipoint-to-point connection. The aforementioned combination may be appropriately configured in compliance with a communications protocol for bi-directional communication.

In an operation with respect to transmitting of traffic and a management message in point-to-multipoint communication, downstream communication for transmission from a root node to a leaf node is performed in a form of unicast traffic, multicast traffic, and broadcast traffic. Upstream communication for transmission from a root node to a leaf node is generally performed in a form of unicast traffic.

An RMP connection protection switching is performed based on a per-leaf protection switching method to which a conventional point-to-point linear protection switching method is applied in which a protection switching is performed by managing a state of a working path and a protection path provided in a point-to-point connection between a root node and a single leaf node, and a per-tree protection switching method in which a point-to-multipoint connection, for example, an RMP connection, is managed by a working tree path and a protection tree path, and a protection switching is performed by managing a state of the working tree path and the protection tree path. These two methods may be set in advance to be operated, or changed in various manners based on standards such as simultaneous failure detection. As used herein, the per-leaf protection switching method refers to a method of switching a working path leading towards a first leaf node to a protection path in an occurrence of a local failure. The per-tree protection switching method refers to a method of switching all working paths within a tree aside from the working path of the first leaf node to a protection path.

According to the present exemplary embodiment, there is provided the per-tree protection switching method, and a method of performing a tree path protection switching in response to a connection path failure or simultaneous failure detection.

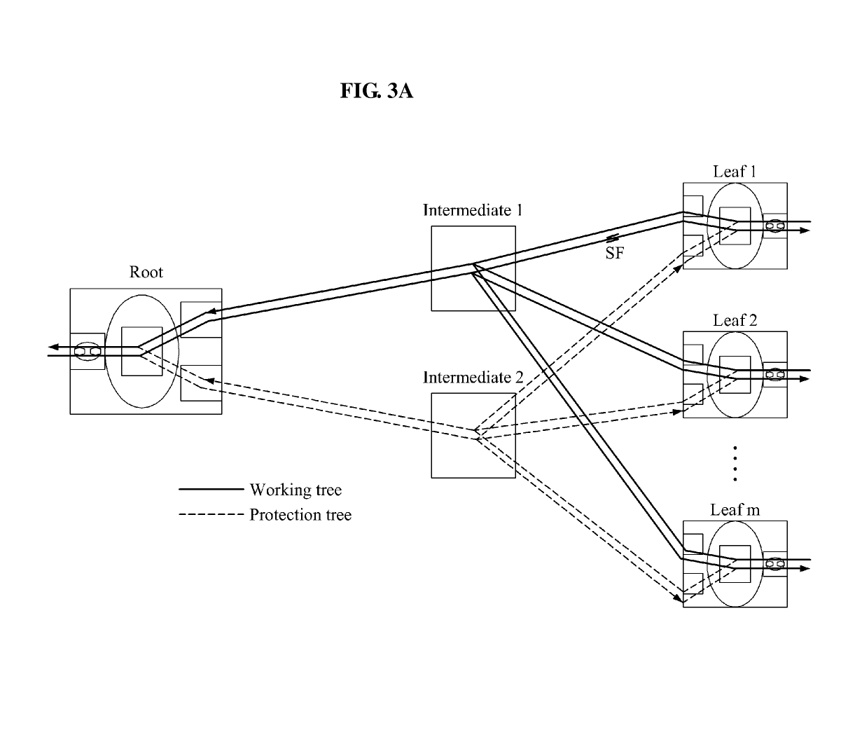

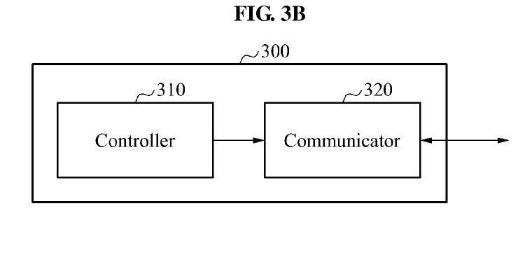

FIG. 3A is a diagram illustrating an example of an occurrence of a signal failure (SF) on a path to a leaf node from a root node in a network to which a protection switching is applied in an RMP connection path according to an embodiment of the present invention. Referring to FIG. 3A, a solid line and a dotted line indicate a uni-directional working tree and a uni-directional protection tree, respectively, between a root node and a plurality of leaf nodes. Based on characteristics of a per-tree protection switching, a message directed from a root node to a plurality of leaf nodes is transmitted to all of the plurality of leaf nodes, and enables all of the leaf nodes belonging to a tree path to perform a switching based on an occurrence of a failure and a command from an operator. A message directed from the plurality of leaf nodes to the root node provides information about failures and operation in commands differing based on a state of the plurality of leaf nodes to the root node.

In the per-tree protection switching, when a plurality of leaf nodes and a root node recognize an occurrence of a failure within a tree path, and when a command to operate is issued within the tree path, the root node performs a switching of the entire tree path, and based on a number of nodes, significance, and a presence of a simultaneous failure, the root node prevents the switching of the entire tree path in response to a portion of the leaf nodes and the root node recognizing the failure and the operation command. According to the present exemplary embodiment, the entire tree path is assumed to be switched by at least one failure and operation command within the tree path. A bridge/selector in the root node and a selector/bridge in the plurality of leaf nodes may be adjusted by a protection switching message, for example, an automatic protection switching protocol message or a protection state coordination protocol message in order to maintain an identical position of the bridge/selector.

When the root node recognizes a failure and commences a protection switching message exchange, the per-tree protection switching may be performed by a single exchange of a protection switching message commencing from the root node between the root node and all of the leaf nodes. However, when a leaf node recognizes a failure and commences a protection switching message exchange, two steps are required to complete an exchange of protection switching messages. In a failure transmitted in both directions, the root node and the leaf node concurrently recognize the failure, or one of the nodes recognizes the failure more rapidly than the other node and commences a protection switching and a message exchange. In a case of a failure transmitted in a single direction, one of the root node and the leaf node recognizes the failure prior to the other node, and commences the protection switching and the message exchange. Hereinafter, an instance of the per-tree protection switching commencing from one of the plurality of leaf nodes will be discussed.

FIG. 3B is a block diagram illustrating a node 300, for example, a root node or a leaf node according to an embodiment of the present invention.

Referring to FIG. 3B, the node 300 includes a controller 310 and a communicator 320.

The controller 310 controls the communicator 320 to perform communication with another node using a predetermined path between a working path and a protection path. The controller 310 may be implemented by an integrated circuit (IC) chip, a microprocessor, or a miniature computer. For example, the controller 310 may include the aforementioned bridge/selector or the selector/bridge, and operate based on protection switching protocols, such as an APS protocol or a PSC protocol. The controller 310 controls a protection switching process by analyzing a message received from the communicator 320, and generates a message required for the switching process. Also, the controller 310 controls the communicator 320 to transmit the generated message to another node.

The communicator 320 performs communication with another node. For example, the communicator 320 transmits a message received from the controller 310 to another node, or transmits a message received from another node to the controller 310. The communicator 320 may include various communication modules, for example, an antenna, a demodulator/modulator, a frequency processing apparatus, a filter, or a packet forwarding database. The communicator 320 performs communication with another node via one of a working path or a protection path, and also performs communication while switching traffic between the working path and the protection path during the protection switching process.

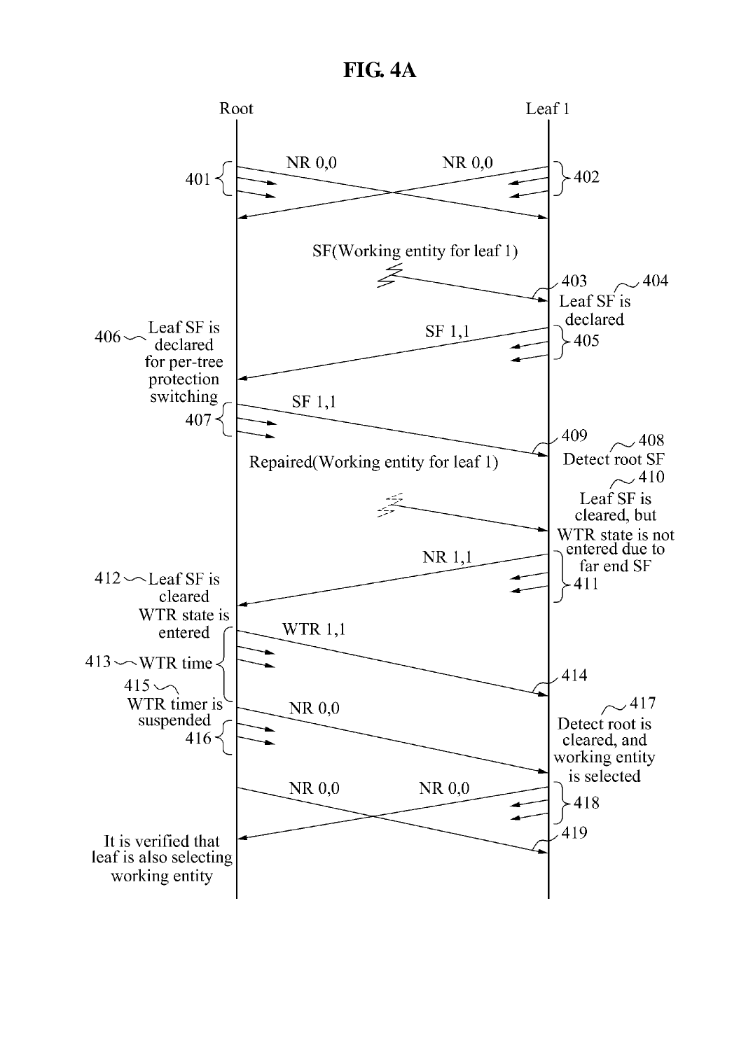

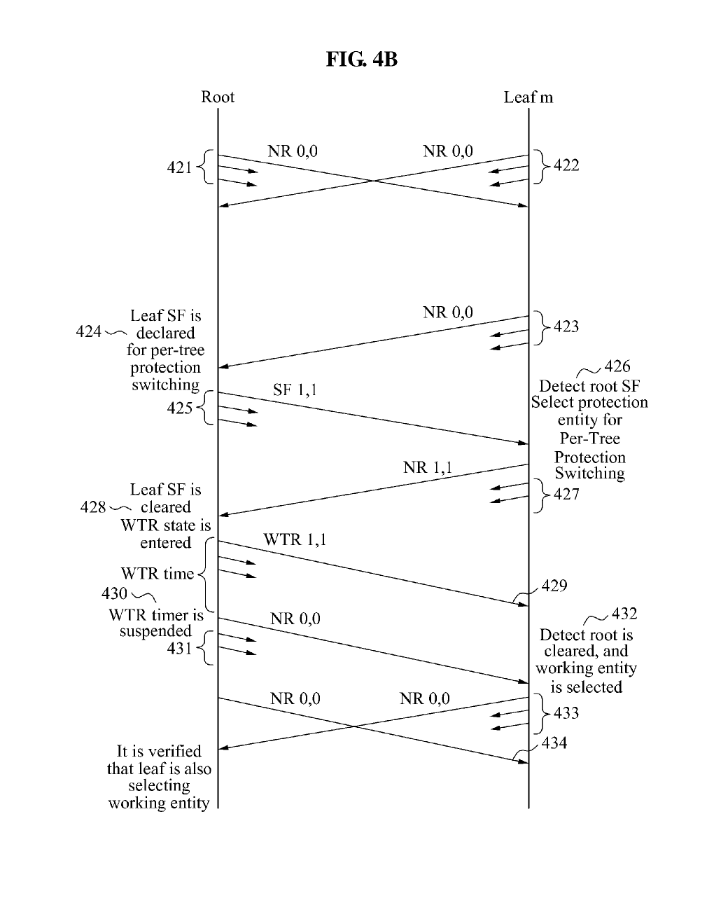

FIGS. 4A and 4B are diagrams illustrating an example of a per-tree protection switching process in a 1:1 revertive mode in an occurrence of the failure of FIG. 3A.

As used herein, a 1:1 scheme refers to a method of transmitting traffic through one of a working tree path or a protection tree path. FIG. 4A illustrates a message exchange between a leaf node detecting a failure and a root node and a process of an operation thereof. FIG. 4B illustrates a message exchange between a leaf node absent a failure and a root node and a process of an operation thereof.

In one example, a message exchanged between nodes may include major state information and r/b information associated with bridge/selector information. “r/b” refers to information used to transmit information about an option of a bridge and a selector associated with a working path and a protection path of a transmitting/receiving node, and received for traffic based on a protection state of a plurality of nodes.
“r” denotes to a requested signal, and information indicating, to the receiving node, that traffic is transmitted through the protection path and received. When the receiving node is a null signal “0”, the transmitting node may not transmit traffic through the protection path. When the receiving node is a normal traffic signal “1”, the transmitting node may recognize that traffic is transmitted through the protection path, and opt for an appropriate selector path.
“b” denotes a transmitted signal, and information indicating that traffic is transmitted through the protection path.

Traffic not being transmitted/received through the protection path based on the 1:1 scheme may indicate that the traffic is transmitted/received through the working path. Description pertaining to “r” and “b” is merely provided as an example of the APS protocol. However, in a different form of a protection switching message, the present invention may be applied through being modified to a different form of information in which when an “r/b” field indicates “0” or a null signal, the working path is used, and when the “r/b” field indicates “1” or a normal traffic signal, the protection path is used.

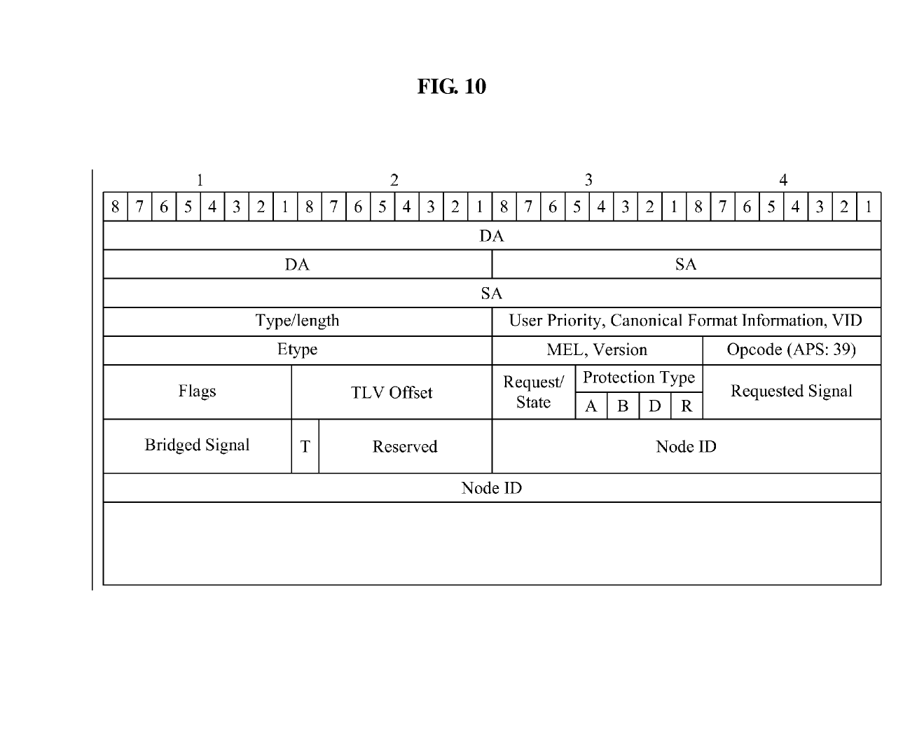

The major state information used in the protection switching message may include a lockout of protection (LO) state in which transmitting/receiving of traffic is locked to be used in a working path, a signal failure for protection (SF-P) state in which a failure is detected on a protection path, a forced switching (FS) state in which traffic is forcefully transmitted/received via a protection path despite an occurrence of a failure, a signal failure for working (SF) state in which a failure is recognized on a working path, a signal degradation (SD) state in which an attenuation of a signal is recognized on a path, a manual switching (MS) state in which a request for a manual switching of a path is recognized, a wait to restore (WTR) state in which waiting is performed while operating a timer during a predetermined period of time until restoration prior to being reverted, an exercise (EXER) state for a trial, a reverse request (RR) state in which responding is performed by a trial, a do not revert (DNR) state in which traffic is transmitted/received via a protection path through a non-reversion, and a no request (NR) state absent a predetermined request or a command. An example of a protection switching message including the aforementioned information will be described with reference to FIG. 10.

The per-tree protection switching according to the present exemplary embodiment is described with reference to FIGS. 4A and 4B.

In operations 401 and 402, a root node and a leaf node transmit/receive a no request (NR) message, hereinafter referred to as an NR message, in a normal state. As used herein, the “normal state” refers to a state prior to an occurrence of a request or failure. The root node and the leaf node transmit/receive traffic through a working path. When the root node receives the NR message from the leaf node, the root node determines that a local failure does not occur in the leaf node. As used herein, an “NR state” refers to a state absent any valid command or request in a current node. In this instance, a bridge and a selector may opt for a working tree path.

In operation 403, a failure occurs on the working tree path.

In operation 404, a leaf node that recognizes the failure declares the failure, and in operation 405, the leaf node transmits a signal failure (r/b=normal traffic signal) message, hereinafter also referred to as an SF message, to the root node in an SF state. A bridge and a selector of the leaf node may opt for a protection tree path. As used herein, “SF” refers to a state in which a current node recognizes an SF state, for example, a working path failure. The SF message refers to a message indicating an occurrence of a failure. The SF message may include information about a request for a conversion to a protection path. For example, a protection switching message may include information about a path failure such as an “r/b” value of an APS protocol and information about a path through which traffic is transmitted/received based on a failure or a request.

In operation 406, when the root node receives the SF (r/b=normal traffic signal) message from the leaf node recognizing an occurrence of a failure, the root node recognizes a far end request SF state of the leaf node recognizing the failure.

In operation 407, the root node transmits an SF message (1, 1) to a leaf node absent a failure. The SF message (1, 1) is transmitted to indicate a failure in a tree when the far end request from the leaf node recognizing the failure is present and when the root node recognizes the failure. A plurality of nodes recognizing a failure indicates that a local SF state is determined.

In operation 408, the leaf node receives the SF message (1, 1), and determines an SF state of the root node.

Although a local SF is unrecognized in the root node for a per-tree protection switching, in response to reception of a far end request, the root node transmits an SF (r/b=normal traffic signal) message (SF (1, 1)) to a plurality of leaf nodes, and the bridge and the selector may opt for the protection tree path. As used herein, (1, 1) may be interchangeably used with a message requesting a conversion to a protection path. A conventional point-to-point protection switching technology, dissimilar to the per-tree protection switching, may include a configuration in which an NR (r/b=normal traffic signal) message is transmitted in an absence of a local SF in a root node.

The protection switching process according to the present exemplary embodiment is directed to the per-tree protection switching administered by the root node. The root node remembers states by classifying into a state in which an SF (r/b=normal traffic signal) message is generated and transmitted by recognizing a local SF of the root node, and a state in which an SF (r/b=normal traffic signal) message is generated and transmitted for a per-tree protection switching for a possibility of an occurrence of an arbitrary failure despite being normal, for example, a virtual SF state. For example, the root node indicates a failure of a predetermined leaf node to a plurality of leaf nodes absent a failure for the per-tree protection switching similar to being in the SF state, such that the per-tree protection switching is performed.

When the leaf node recognizing the occurrence of the failure receives an SF (r/b=normal traffic signal) message from the root node, the per-tree protection switching process is verified to be performed.

In the per-tree protection, whether to perform protection switching is determined based on a highest priority request within a target domain. To this end, the root node compares a priority of a far end request from a plurality of leaf nodes to a local request, sends the highest priority request to the plurality of leaf nodes, and propagates the highest priority request within the domain.

In operation 409, the failure on a working path is cleared. A state in which a failure is cleared is referred to as a Clear SF. In operation 410, the plurality of nodes declares the Clear SF.

A leaf node recognizing the Clear SF maintains a bridge and a selector on a protection tree path in response to a previously received far end SF request SF state of the root node. In operation 411, the leaf node transmits an NR (r/b=normal traffic signal) message, hereinafter also referred to as “NR (1, 1)” or “NR 1, 1”, being a message absent a failure indicating a use of a protection tree path. In operation 412, the root node receives the indication of the Clear SF of the leaf node, and enters a WTR state. As used herein, in a process in which a failure occurs on a working path and is cleared through restoration, the WTR refers to a state of waiting while operating a WTR timer until restoration is completed during a predetermined period of time in which a path is reverted from a protection path to the working path in a revertive mode. A non-revertive mode refers to a mode in which a protection path is continuously used although a failure occurs on a working path and is cleared through restoration. Descriptions pertaining to the non-revertive mode will be provided in further detail later. When the root node receives an NR (r/b=normal traffic signal) message from the leaf node recognizing the Clear SF, the root node recognizes the Clear SF of the leaf node. Subsequently, the root node enters a WTR state to revert from a virtual SF state in which a local SF of the leaf node is unrecognized and an SF (r/b=normal traffic signal) message is transmitted for a per-tree protection switching despite being normal, and operates a WTR timer in operation 413.

In operation 414, the root node transmits a WRT (r/b=normal traffic signal) message, hereinafter also referred to as “WTR (1,1)”, “WTR 1,1”, or “message Y”, being a message indicating that a WTR timer is in operation and a protection tree path is used in response to a failure being cleared.

When an additional request is absent from the root node, and the WTR timer is suspended in operation 415, the root node enters an NR state, and transmits an NR (r/b=null signal) message, for example, a message indicating a use of a working tree path in operations 416 and 419. The bridge and the selector may opt for the working tree path, and as a result, a path is reverted.

In this instance, the root node propagates the NR message to the leaf node in an absence of an additional request. When a node operates in a non-revertive mode, the root node may further perform transmitting a DNR message to the plurality of leaf nodes, in lieu of transmitting a WTR message. In operations 417 and 418, when leaf nodes in an NR state receive an NR (r/b=null signal) message, the NR (r/b=null signal) message is transmitted by a revertive mode operation, a working tree path is selected, and the path is reverted. At this point, a revertive restoration process of all tree paths is completed.

FIG. 4B is a timing diagram illustrating operations of a root node and a leaf node absent an occurrence of a failure.

In operations 421, 422, and 423, the root node and the leaf node transmit/receive an NR message.

As described above, in operation 424, when the root node receives an SF (r/b=normal traffic signal) message from a leaf node recognizing an occurrence of a failure, the root node recognizes a far end request SF state with respect to the leaf node recognizing the failure. In operation 452, the root node transmits an SF message to a leaf node absent a failure. The SF message refers to a message instructing a leaf node that does not recognize a local failure from among a plurality of leaf nodes to perform a switching.

In operation 426, when the leaf node absent the failure receives an SF (r/b=normal traffic signal) message from the root node, the leaf node recognizes a far end request SF state. In this instance, a bridge and a selector may opt for a protection tree path, and the leaf node transmits an NR (r/b=normal traffic signal) message, for example, “NR (1, 1)” or “NR 1, 1”, being a message indicating an absence of a failure or request and a use of a protection tree path in operation 427. At this point, a traffic switching to the protection tree path is performed.

The root node receiving an NR (r/b=normal traffic signal) message from the leaf node absence the failure verities that the traffic switching is performed based on the per-tree protection switching.

As described above, in operation 428, the root node receives an indication of a Clear SF of a leaf node, and enters a WTR state. The root node operates a WTR timer.

In operation 429, the root node transmits a WTR (r/b=normal traffic signal) message, hereinafter also referred to as, “WTR (1, 1)”. “WTR 1, 1”, or “message Y”, being a message indicating that a WTR timer is in operation and a protection tree path is used in response to a failure being cleared.

When an additional request is absent from the root node, and the WTR timer is suspended in operation 430, the root node enters an NR state, and transmits an NR (r/b=null signal) message in operations 431 and 434. The bridge and the selector may opt for the working tree path, and as a result, a path may be reverted.

In operations 432 and 433, when leaf nodes in an NR state receive an NR (r/b=null signal) message, the NR (r/b=null signal) message is transmitted by a revertive mode operation, a working tree path is selected, and the path is reverted. At this point, a revertive restoration process of all tree paths is completed.

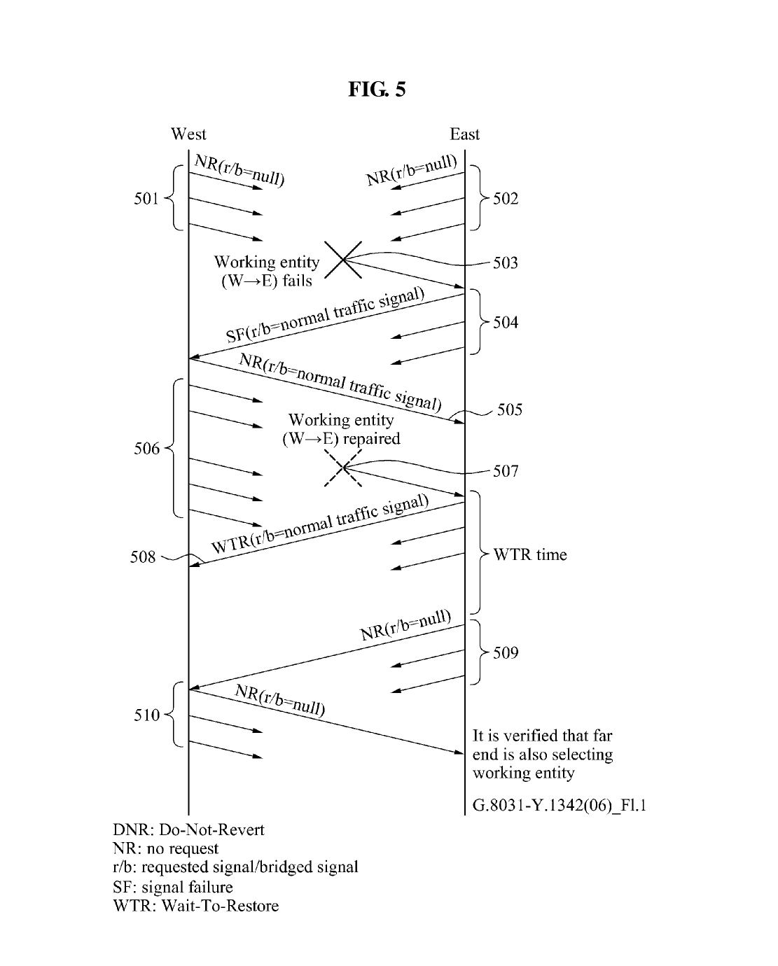

FIG. 5 is a timing diagram illustrating a switching process according to an example of a revertive restoration process based on a conventional linear protection switching method.

Descriptions previously provided in FIGS. 4A and 4B may be applied to operations 501 through 507 in FIG. 5 and thus, repeated descriptions will be omitted here for conciseness. According to the present exemplary embodiment of FIG. 5, a leaf node enters a WTR mode when a failure is restored. In operation 508, the leaf node transmits a WTR message to a root node. In operation 509, the leaf node transmits an NR message to the root node when a WTR timer is suspended. In operation 510, the root node transmits the NR message to the leaf node correspondingly. The leaf node receiving the NR message verifies that the root node performs a switching. As described above, the WTR mode such as the WTR message transmitting or the operation of the WTR timer may be implemented by the root node or the leaf node in various manners.

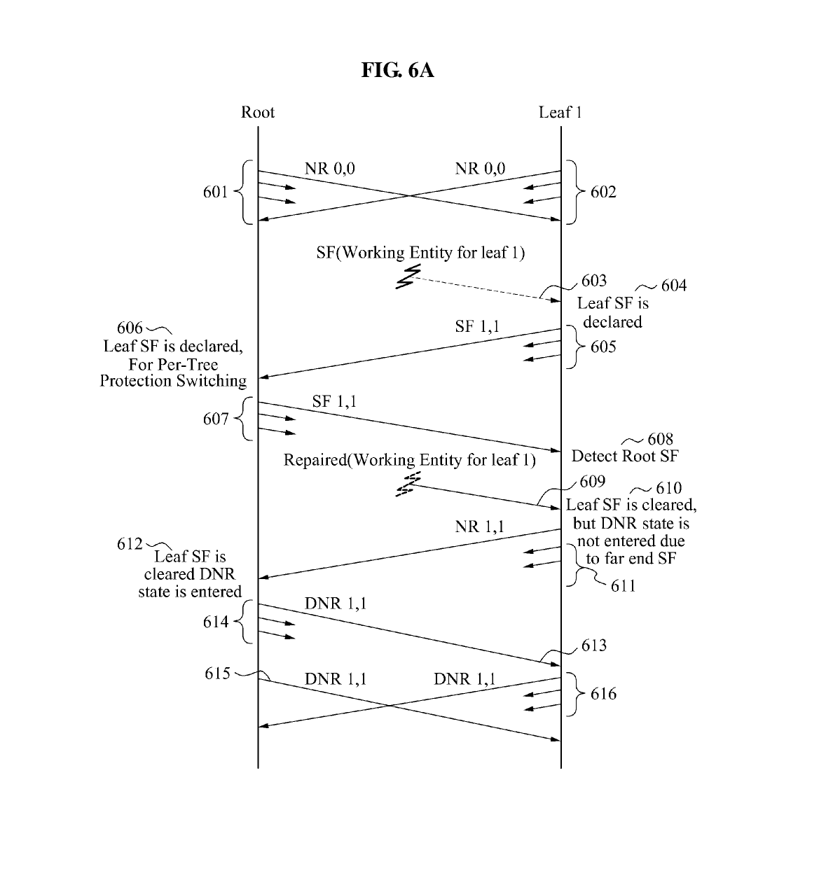

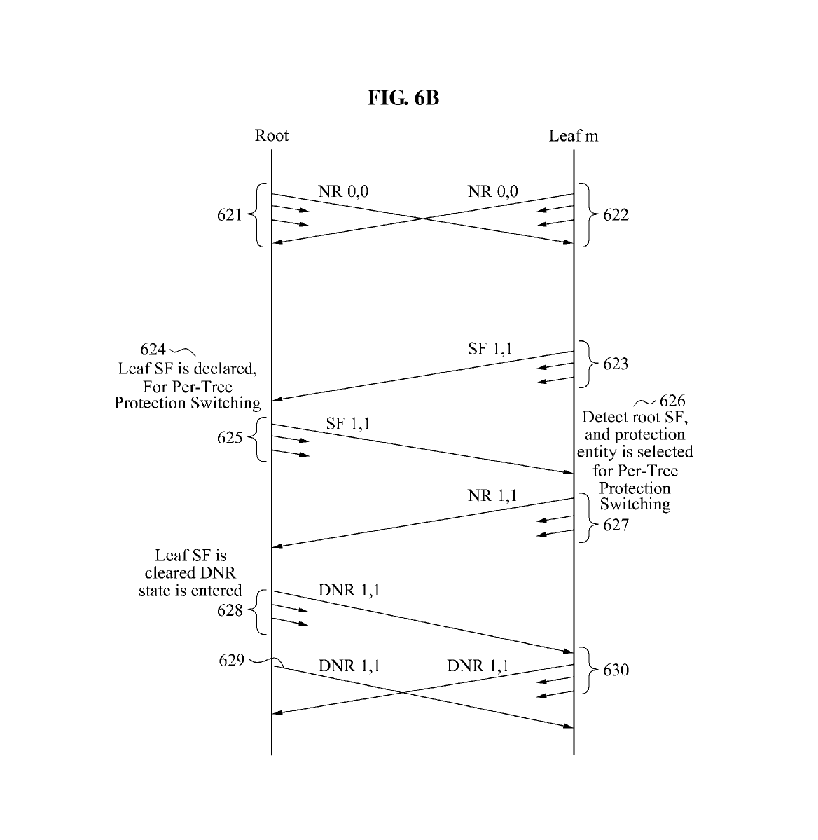

FIGS. 6A and 6B are timing diagrams illustrating a per-tree protection switching process in a 1:1 non-revertive mode according to another embodiment of the present invention. As used herein, the “non-revertive mode” refers to a mode in which using a protection path is maintained despite a failure occurring on a working path being cleared when traffic is transmitted through the protection path by a protection switching.

FIG. 6A illustrates a message exchange between a leaf node detecting a failure and a root node and a process of an operation thereof. FIG. 6B illustrates a message exchange in between a leaf node absent a failure and a root node and a process of an operation thereof.

In operations 601 and 602 or in operations 621, 622, and 623, a root node and a leaf node are in a normal state prior to an occurrence of a failure, and transmit/receive an NR message. Here, a bridge and a selector may opt for a working tree path.

When a failure occurs on the working tree path in operation 603, and the leaf node recognizes the failure in operation 604, the leaf node transmits an SF (r/b=normal traffic signal) message in an SF state, and the bridge and the selector may opt for a protection tree path in operation 605.

A leaf node that does not recognize the failure has no change in a state.

In operation 606 or 624, when the root node receives the SF (r/b=normal traffic signal) message from the leaf node recognizing the failure, the root node recognizes a far end request SF state with respect to the leaf node recognizing the failure.

In operation 607 or 625, although a local SF is unrecognized in the root node for a per-tree protection switching, in response to reception of a far end request, the root node transmits an SF (r/b=normal traffic signal) message to a plurality of leaf nodes, and the bridge and the selector may opt for the protection tree path.

According to the present exemplary embodiment, a per-tree protection switching is administered by the root node. The root node remembers states by classifying into a state in which an SF (r/b=normal traffic signal) message is generated and transmitted by recognizing a local SF of the root node, and a state in which an SF (r/b=normal traffic signal) message is generated and transmitted for a per-tree protection switching for a possibility of an occurrence of an arbitrary failure despite being normal, for example, a virtual SF state. For example, the root node indicates a failure of a predetermined leaf node to a plurality of leaf nodes absent a failure for the per-tree protection switching similar to being in the SF state, such that the per-tree protection switching is performed.

In operation 608, when the leaf node recognizing the occurrence of the failure receives an SF (r/b=normal traffic signal) message from the root node, the per-tree protection switching process is verified to be performed.

In operation 626, when the leaf node absent the failure receives an SF (r/b=normal traffic signal) message from the root node, the leaf node recognizes a far end request SF state. In this instance, a bridge and a selector may opt for a protection tree path, and the leaf node transmits an NR (r/b=normal traffic signal) message in operation 627. At this point, a traffic switching to the protection tree path is performed.

The root node receiving an NR (r/b=normal traffic signal) message from the leaf node absent the failure verifies that the traffic switching is performed based on the per-tree protection switching.

In operation 609, the failure on the working path is cleared.

In operation 610, in a non-revertive mode, the leaf node recognizes a Clear SF.

However, the bridge and the selector may maintain the protection tree path in response to a previously received far end request SF state of the root node. The leaf node may transmit the NR (r/b=normal traffic signal) message, and indicate that the Clear SF of the leaf node in operation 611.

In operation 612, when the root node receives an NR (r/b=normal traffic signal) message from the leaf node recognizing the Clear SF, the root node recognizes the Clear SF of the leaf node. Subsequently the root node enters a DNR state for a non-reversion from the virtual SF state in which a local SF of the leaf node is unrecognized and an SF (r/b=normal traffic signal) message is transmitted for a per-tree protection switching despite being normal, and transmits a DNR (r/b=normal traffic signal) message in operations 613, 614, and 615 or operations 628 and 629. As used herein, in a process in which a failure occurs on a working path and is cleared by being restored. “DNR” refers to a state in which transmitting/receiving of traffic is maintained on the protection path despite an absence of the failure on the working path in a non-revertive mode.

A leaf node absent a failure performs a protection switching in operation 626, and transmits an NR message to the root node in operation 627.

In operations 616 and 630, when leaf nodes in an NR state receive a DNR (r/b=normal traffic signal) message, the DNR (r/b=normal traffic signal) message is transmitted by a non-revertive mode operation, the protection tree path is selected to maintain the non-revertive state. At this point, a non-revertive restoration process of all tree paths is completed.

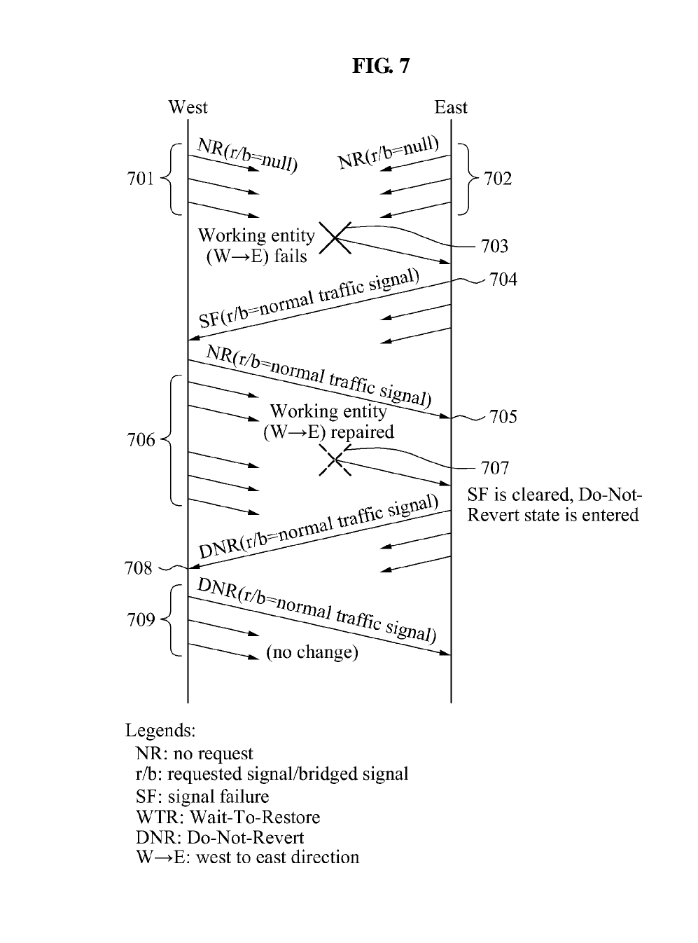

FIG. 7 is a timing diagram illustrating a switching process according to an example of a non-revertive restoration process based on a linear protection switching method.

Descriptions previously provided in FIGS. 6A and 6B may be applied to operations 701 through 707 in FIG. 7 and thus, repeated descriptions will be omitted here for conciseness. According to the present exemplary embodiment of FIG. 7, in operation 708, a leaf node transmits a DNR message when a failure is cleared. In operation 709, the root node transmits the DNR message to the leaf node correspondingly. As described above, the DNR message transmitting may be implemented by the root node or the leaf node in various manners.

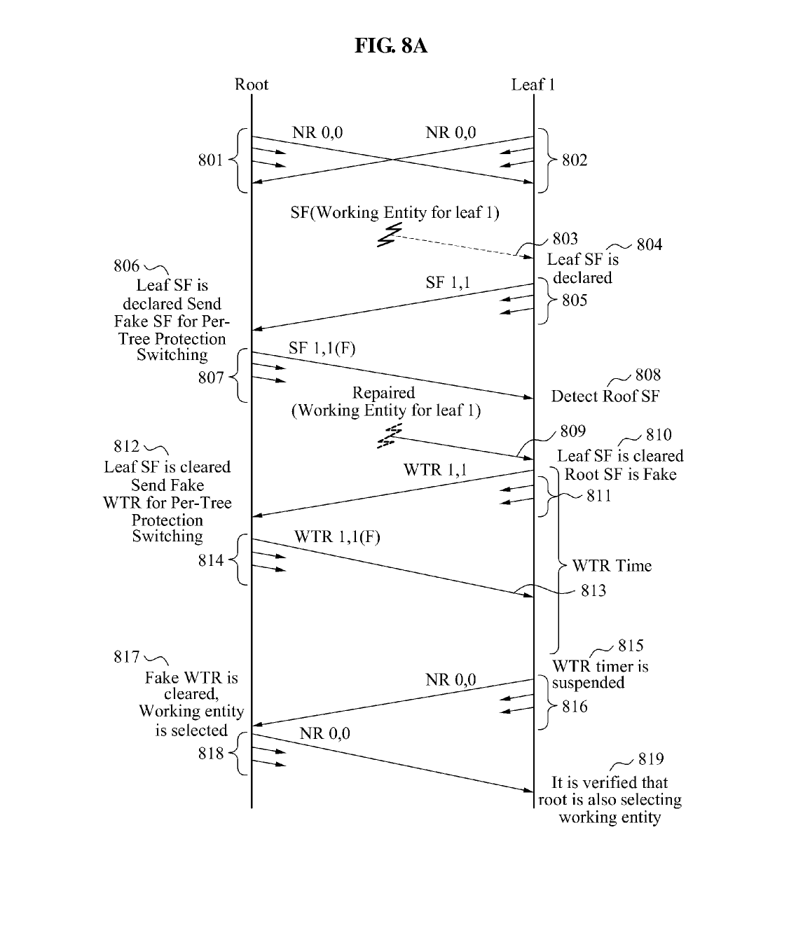

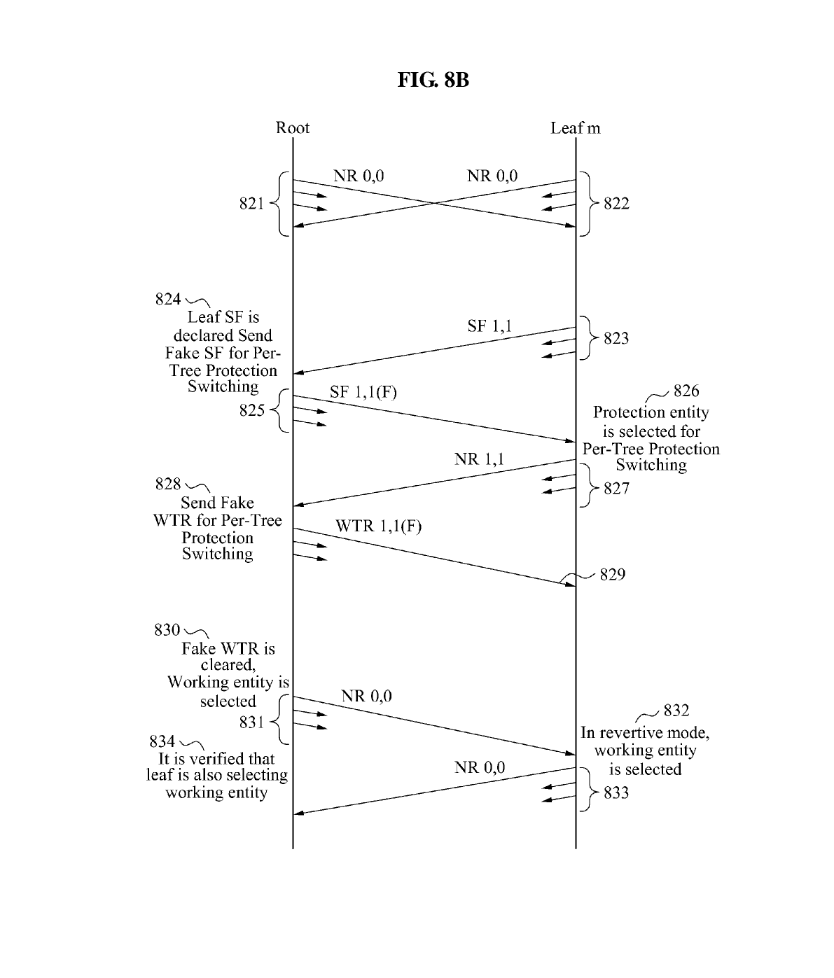

FIGS. 8A and 8B are timing diagrams illustrating another per-tree protection switching process in a 1:1 revertive mode in an occurrence of the failure of FIG. 3A. FIG. 8A illustrates a message exchange between a leaf node detecting a failure and a root node and a process of an operation thereof. FIG. 8B illustrates a message exchange between a leaf node absent a failure and a root node and a process of an operation thereof.

In operations 801 and 802 or in operations 821, 822, and 823, a root node and a leaf node are in a normal state prior to an occurrence of a failure, and transmit/receive an NR message. Here, a bridge and a selector may opt for a working tree path.

When a failure occurs on the working tree path in operation 803, and the leaf node recognizes the failure in operation 804, the leaf node transmits an SF (r/b=normal traffic signal) message in an SF state, and the bridge and the selector may opt for a protection tree path in operation 805.

A leaf node that does not recognize the failure exhibits no change in a state.

In operation 806 or 824, when the root node receives the SF (r/b=normal traffic signal) message from the leaf node recognizing the failure, the root node recognizes a far end request SF state with respect to the leaf node recognizing the failure.

In operation 807 or 825, the root node transmits an SF (r/b=normal traffic signal) message including information indicating that an occurrence of a failure on the root node is fake to a plurality of leaf nodes because a local SF is unrecognized in the root node for a per-tree protection switching. Here, the bridge and the selector may opt for the protection tree path.

As used herein. “SF message” refers to declaring an SF as Fake (F) information for a per-tree protection switching although an actual SF does not occur in the root node. In operation 808, the leaf node receiving the SF message via the F information determines the SF message to be fake rather than an actual request. For example, the root node transmits an SF message that does not include the F information when the root node recognizes an actual failure in the root node, and includes the F information when a predetermined leaf node receives an indication of a failure and the root node does not recognize a failure.

According to the present exemplary embodiment, a per-tree protection switching is administered by the root node. The root node remembers states by classifying into a state in which an SF (r/b=normal traffic signal) message is generated and transmitted by recognizing a local SF of the root node, and a state in which an SF (r/b=normal traffic signal) message is generated and transmitted for a per-tree protection switching for a possibility of an occurrence of an arbitrary failure despite being normal, for example, a virtual SF state. For example, the root node indicates a failure of a predetermined leaf node to a plurality of leaf nodes absent a failure for the per-tree protection switching similar to being in the SF state, indicates the F information, and transmits the F information, such that the per-tree protection switching is performed.

When the leaf node recognizing the occurrence of the failure receives a fake SF (r/b=normal traffic signal) message from the root node, performance of the per-tree protection switching process is verified.

In operation 826, when the leaf node absent the failure receives the fake SF (r/b=normal traffic signal) message from the root node, the leaf node recognizes a far end request SF state. In this instance, a bridge and a selector may opt for a protection tree path for the per-tree protection switching, and the leaf node transmits an NR (r/b=normal traffic signal) message in operation 827. At this point, a traffic switching to the protection tree path is performed.

The root node receives the NR (r/b=normal traffic signal) message from the leaf node absent the failure in operation 827, and verifies that the traffic switching is performed based on the per-tree protection switching.

In operation 809, the failure is cleared.

In operation 810, the leaf node recognizing the failure recognizes a Clear SF. The leaf node enters a WTR state for a reversion, operates a WTR timer, and transmits a WTR (r/b=normal traffic signal) message in operation 811 because the leaf node is aware of a previously received fake far end request SF state of the root node, and an absence of an actual failure on a current tree path.

In operation 812, when the root node receives the WTR (r/b=normal traffic signal) message from the leaf node, the root node recognizes the Clear SF. In operations 813, 814, and 815 or operations 828 and 829, the root node transmits a fake WTR (r/b=normal traffic signal) message to the plurality of leaf nodes for the per-tree protection switching. In this example, “WTR message” indicates that a WTR timer operates for the per-tree protection switching due to recognition of the failure of the leaf node being cleared rather than a Clear in SF of the root node.

When a plurality of leaf node absent a failure receives the fake WTR (r/b=normal traffic signal) message, a message transmitting state is maintained.

When an additional request is absent from the root node subsequent to the Clear SF, and the WTR timer is suspended in operation 815, the root node enters an NR state, and transmits an NR (r/b=null signal) message in operation 816. The bridge and the selector may opt for the working tree path, and as a result, a path is reverted.

In operations 817 and 818 or operations 830 and 831, when the root nodes receives an NR (r/b=null signal) message, the transmitting of the fake WTR (r/b=normal traffic signal) message is suspended, the NR (r/b=null signal) message is transmitted by a revertive mode operation, a working tree path is selected, and the path is reverted. In operation 819, the leaf node receiving the NR message verifies that the root node switches to the working path.

In operations 832 and 833, when a plurality of leaf nodes in an NR state receives the NR (r/b=null signal) message, the NR (r/b=null signal) message is transmitted by a revertive mode operation, the working tree path is selected, and the path is reverted. At this point, a revertive restoration process of all tree paths is completed. In operation 834, the leaf node receiving the NR message verifies that remaining leaf nodes switch to the working path based on path information, for example, “r/b”, in an instance of an APS, provided within the NR message.

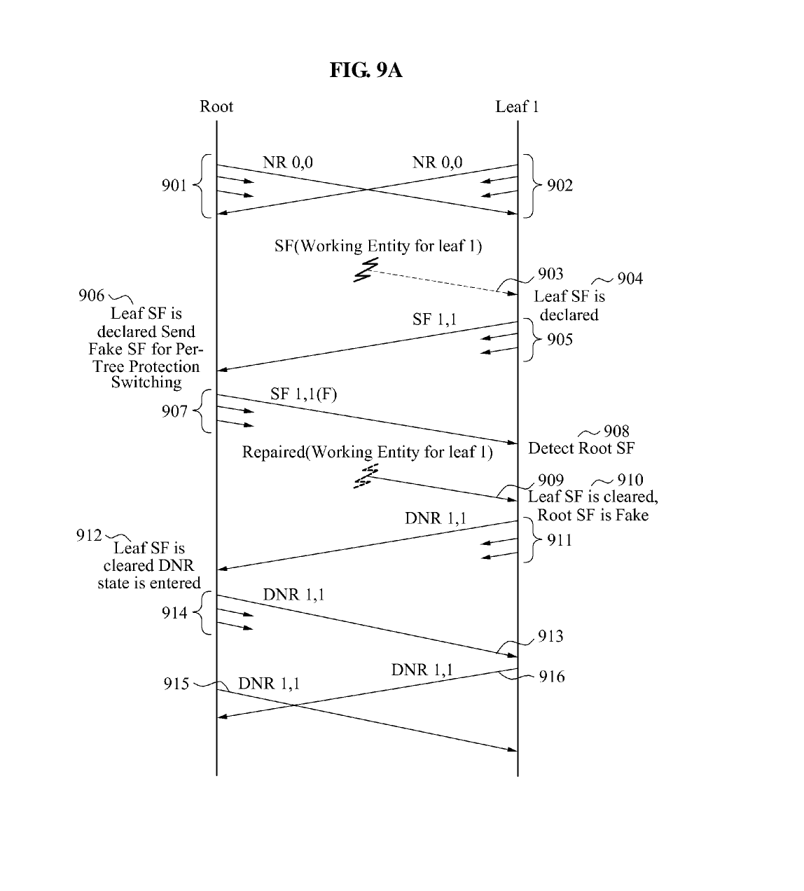

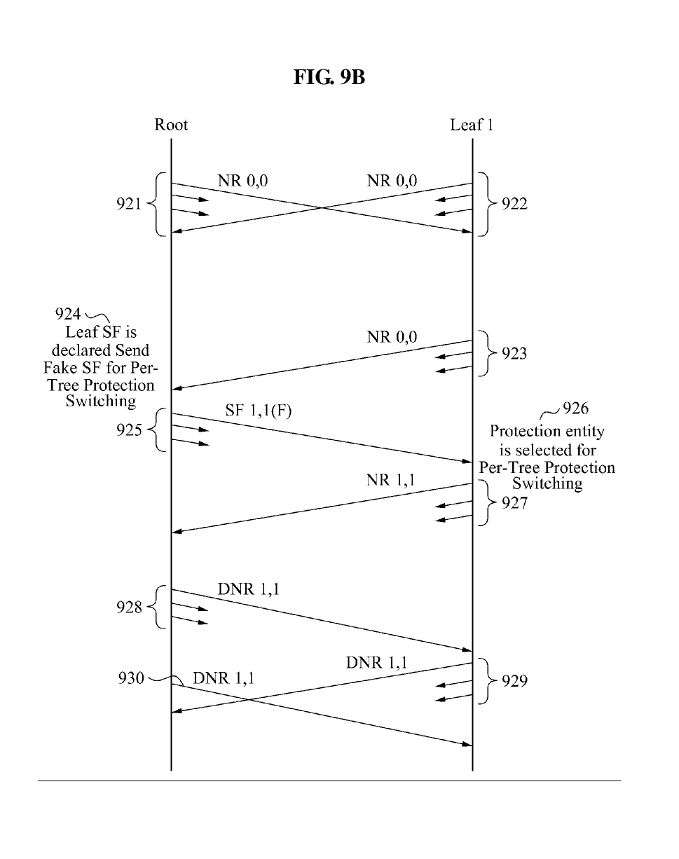

FIGS. 9A and 9B are diagrams illustrating another per-tree protection switching process in a 1:1 non-revertive mode in an occurrence of the failure of FIG. 3A. FIG. 9A illustrates a message exchange between a leaf node detecting a failure and a root node and a process of an operation thereof. FIG. 8B illustrates a message exchange between a leaf node absent a failure and a root node and a process of an operation thereof.

In operations 901 and 902 or in operations 921, 922, and 923, a root node and a leaf node are in a normal state prior to an occurrence of a failure, and transmit/receive an NR message. Here, a bridge and a selector may opt for a working tree path.

When a failure occurs on the working tree path in operation 903, and the leaf node recognizes the failure in operation 804, the leaf node transmits an SF (r/b=normal traffic signal) message in an SF state, and the bridge and the selector may opt for a protection tree path in operation 905. A leaf node that does not recognize the failure exhibits no change in a state.

In operation 906 or 924, when the root node receives the SF (r/b=normal traffic signal) message from the leaf node recognizing the failure, the root node recognizes a far end request SF state with respect to the leaf node recognizing the failure.

In operation 907 or 925, the root node transmits the SF (r/b=normal traffic signal) message including information to a plurality of leaf nodes although a local SF is unrecognized in the root node for a per-tree protection switching, and the bridge and the selector may opt for the protection tree path.

According to the present exemplary embodiment a per-tree protection switching is administered by the root node. The root node transmits an SF message including information indicating that the root node is fake or an SF message not including the root node is fake to a plurality of leaf nodes by recognizing a local SF of the root node. The bridge and the selector may opt for the protection tree path. For example, the SF (r/b=normal traffic signal) message is transmitted, and an actual root node detects an occurrence of an SF. The leaf node receiving the SF message determines that the local SF of the root node is detected.

According to the present exemplary embodiment, a per-tree protection switching is administered by the root node. The root node remembers states through a classification into one of a state in which an SF (r/b=normal traffic signal) message is generated and transmitted by recognizing a local SF of the root node, and a state in which an SF (r/b=normal traffic signal) message is generated and transmitted for a per-tree protection switching for a possibility of an occurrence of an arbitrary failure despite being normal, for example, a virtual SF state. For example, the root node indicates a failure of a predetermined leaf node to a plurality of leaf nodes absent a failure for the per-tree protection switching similar to being in the SF state, indicates the F information, and transmits the F information, such that the per-tree protection switching is performed.

When the leaf node recognizing the occurrence of the failure receives the SF (r/b=normal traffic signal) message from the root node, performance of the per-tree protection switching process is verified.

In operation 926, when the leaf node absent the failure receives the fake SF (r/b=normal traffic signal) message from the root node, the leaf node recognizes a far end request SF state. In this instance, a bridge and a selector may opt for a protection tree path for the per-tree protection switching, and the leaf node transmits an NR (r/b=normal traffic signal) message in operation 927. At this point, a traffic switching to the protection tree path is performed.

The root node receiving the NR (r/b=normal traffic signal) message from the leaf node absent the failure verifies that the traffic switching is performed based on the per-tree protection switching.

In operation 909, the failure on the working path is cleared.

In operation 910, the leaf node recognizing the failure recognizes a Clear SF. The leaf node is aware of a previously received fake far end request SF state of the root node, and an absence of an actual failure on a current tree path. Therefore, the bridge and the selector maintain the protection tree path, transmit a DNR (r/b=normal traffic signal) message, and indicate a Clear SF of the leaf node in operation 911.

In operation 912, when the root node receives the DNR (r/b=normal traffic signal) message from the leaf node recognizing the Clear SF, the root node recognizes that the far end request SF is cleared. In operations 913, 914, and 915 or operations 928 and 929, the root node enters a DNR state for a non-reversion to revert from a virtual SF state in which a local SF of the leaf node is unrecognized and an SF (r/b=normal traffic signal) message is transmitted for a per-tree protection switching despite being normal. The leaf node transmits the DNR message to the root node in operation 916.

When the plurality of leaf nodes exists in the NR state as shown in FIG. 9, the DNR (r/b=normal traffic signal) message is transmitted by a non-revertive mode operation, the protection tree path is selected, and a non-revertive state is maintained. At this point, a non-revertive restoration process of all tree paths is completed in operation 929.

When the above example is applied to a 1+1 scheme, an option with respect to a selector operates in the same manner as described above while an option with respect to a bridge is selected as “b=normal traffic signal” at all times. The 1+1 scheme refers to a scheme in which both a working path and a protection path transmit traffic to a transmitting end, and a receiving end receive one of the working path and the protection path.

In an instance of end-to-end commands, for example, an LO command, an FS command, or an MS command, when a root node receives a far-end request message indicating that a predetermined end-to-end command is applied from a leaf node, a far end request state is recognized as in the protection switching process in response to the occurrence of SF. The root node transmits a corresponding end-to-end command message to a plurality of leaf nodes, and opts for a tree path appropriate for the end-to-end command in a similar manner to an instance in which applying an actual corresponding end-to-end command to the root node is unnecessary when the far-end request command recognized by the root node is valid in a priority.

The above process is directed to the per-tree protection switching administered by the root node according to the present exemplary embodiment. For example, the per-tree protection switching is performed by the root node indicating, to the plurality of leaf nodes, similar to an identical end-to-end command being applied with respect to an end-to-end command application of a predetermined leaf node for the per-tree protection switching, such that the per-tree protection switching is performed.

The root node and the plurality of leaf nodes have a protection switching process. Protection switching messages are exchanged between the root node and the plurality of leaf nodes in order to adjust positions of a bridge and a selector of the root node and the plurality of leaf nodes.

The protection switching messages, hereinafter also referred to as an APS message or an APS protocol message, are transmitted between the root node and the plurality. A protection switching message generated by the root node is transmitted to all of the leaf nodes, however, a protection message generated by the plurality of leaf nodes is transmitted to the root node. The protection message transmitted from the plurality of leaf nodes is to be identified by the root node. The identifying is performed by assigning different identifiers (ID), for example, a virtual local area network (VLAN) identifier (ID), hereinafter also referred to as VID, in an instance of Ethernet, for a protection path in a direction from the plurality of leaf nodes to the root node. Conversely, when all of the leaf nodes use an identical VID for the protection path, for example, an identical VID in a case of an Ethernet, the protection message includes information, for example, a node ID, indicating an ID of a source of the protection switching message to the root node.

FIG. 10 is a diagram illustrating an example of a protection switching message form in an Ethernet according to an embodiment of the present invention.

“DA” refers to an Ethernet media access control (MAC) destination address. “SA” refers to an Ethernet MAC sender information, “° Type/length” refers to a length of an Ethernet frame or an Ethernet type, and “VLAN information” used in IEEE 802.1Q/VLAN includes “user priority, canonical format information, and VID”.

“Etype” includes information about a type of an Ethernet message appearing in a subsequent area.

Information fields for Y.1731 Ethernet OAM includes “MEL, Version, Opcode, Flags, or TLV Offset”. When Opcode is “39”, an APS message appears in a subsequent area.

Field areas for a plurality of protection switching APS messages include “requested signal”. “transmitted signal”. “T”, for example, a bridge type indicating whether a bridge used to bridge is a selector bridge or a broadcast bridge, or “reserved”.

First four bytes of the protection switching message are the same as an APS message of ITU-T G8031, however, an Internet Engineering Task Force (IETF) PSC message may also be applied. According to the present exemplary embodiment, an ID of a node transmitting a protection switching message is added such that a root node may distinguish a leaf node that transmits the protection switching message. The node ID may use a leaf node MAC address in six bytes as shown in FIG. 10, and use a different form of a determiner in a predetermined size. Node ID information uses a reserved area in an existing protection switching message.

When a protection switching message is transmitted from the leaf node to the root node via an exclusive channel, or a sender leaf node is distinguishable based on frame header information including the protection message, a node ID within the protection switching message may be omitted.

F information indicating that a protection switching message transmitted from a root node to a leaf node does not correspond to a state of the root node, or propagation (P) information indicating that a higher priority request from among a plurality of protection switching messages received from a plurality of leaf nodes is transmitted by the root node in lieu of the leaf node may be included in the protection switching message in a form of a one byte flag. An F flag or a P flag may employ a reserved area in an existing protection switching message, be indicated at a predetermined position to be transmitted. The F information and the P information may use both or one of the F flag and the P flag to include both functions.

Functions of an F field or a P field according to the present exemplary embodiment may be employed to operate the aforementioned WTR timer, and used to provide information for mediating an identical priority request occurring in differing lead nodes.

“MS” indicating a manual command in CL8031 standards refers to a manual switching through a protection path, and “MS-W” refers to a manual switching through a working path. MS is also referred to as “MS-P”. The MS command and the MS-W command have the same priority, and operate on a “first-come, first-served” basis. When a request input is accepted and an operation commences, another request having the same priority is not accepted. When two difference requests are concurrently input, the MS-W command is prioritized. As used herein, “concurrently” refers to a point in time until a response with respect to a command instructed from a local node is received by a counterpart node. For example, when an operator inputs an MS command to a node, the node executes the MS command, transmits the MS command to a counterpart node via a message, and receives an MS-W command in lieu of a response, for example, “NR 1, 1”, with respect to the MS command from the counterpart node. As a result, the MS command and the MS-W command are determined to be concurrently input to the two nodes.

In the protection switching method in the RMP network according to the present exemplary embodiment, a root node receives an MS command, for example, MS (1, 1), from a leaf node, and transmits MS (1, 1) in lieu of NR (1, 1) as a response to all leaf nodes. Accordingly, the leaf node transmitting the MS (1, 1) recognizes the MS (1, 1) received from the root node as a response, and determines that the MS command is accepted. However, when another leaf node concurrently transmits an MS-W command, the leaf node transmits MS (0, 0) to the root node. However, the root node ignores the MS-W command and continuously transmits MS (1, 1) indicating a manual switching through a protection path to all of the leaf nodes because the root node receives the MS command requested from the other leaf node. In this example, the leaf node receiving the MS-W command determines that differing requests having an identical priority are concurrently made and continuously maintains the MS-W command because the leaf node receives another request MS (1, 1) rather than a response with respect to MS (0, 0) transmitted from the leaf node. Accordingly, the root node and all of the leaf nodes excluding the leaf node receiving the MS-W command switch traffic through a protection path. The leaf node receiving the MS-W command maintains a working path through which traffic is switched, and a disconnection occurs in transmitting the traffic in the RMP network.

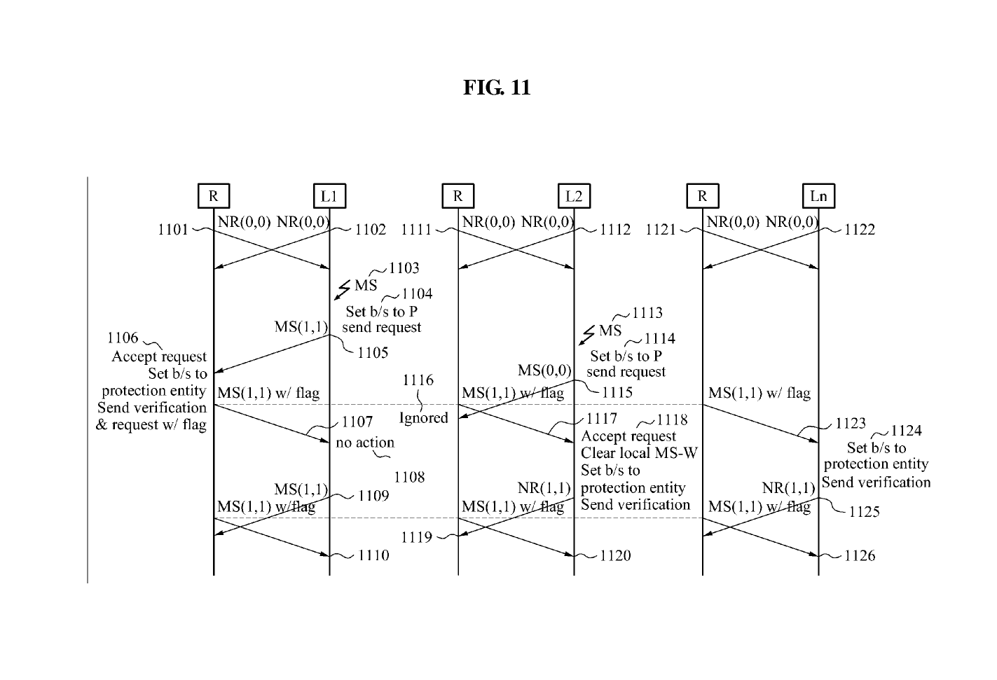

FIG. 11 is a diagram illustrating an example of using an F or P flag to resolve the aforementioned issues according to embodiments of the present invention. Referring to FIG. 11, a protection switching is performed when an MS command and an MS-W command are concurrently instructed to Leaf node 1 and Leaf node 2 in an RMP network including a plurality of leaf nodes, for example, L1 . . . Ln, and a single root node (R). It is noted that the P flag is used for indication in FIG. 11.

In operations 1101 and 1102, the root node transmits/receives an NR message with Leaf node 1. In operations 1111 and 1112, the root node transmits/receives an NR message with Leaf node 2. In operations 1121 and 1122, the root node transmits/receives an NR message with Leaf node 3.

In operation 1103, Leaf node 1 receives an input of an MS command. In operation 1104, Leaf node 2 receives an input of an MS command. As used herein, MS command refers to a request command for a manual switching through a protection path as previously described, and MS-W command refers to a request command for a manual switching through a working path.

In operation 1104, Leaf node 1 switches traffic through a protection tree, and transmits MS (1, 1) request to the root node in operation 1105.

In operation 1114, Leaf node 2 maintains a traffic switching through a working tree, and transmits MS (0, 0) request to the root node in operation 1115.

When the root node processes the MS (1, 1) received from the leaf node first in operation 1106, the root node accepts the request, switches traffic through the protection tree, sets the P flag to a protection switching message, includes the received MS (1, 1) request in the protection switching message, and transmits the MS (1, 1) request- to all of the leaf nodes in operations 1107, 1117, and 1123.

In operation 1116, when MS (0, 0) is received from Leaf node 2, the root node ignores the MS (0, 0) request because the root node accepts the MS (1, 1) request prior to the MS (0, 0).

In operation 1108, when Leaf node 1 receives the MS (1, 1) request set to the P flag from the root node, Leaf node 1 determines the MS (1, 1) request to be a response and maintains a current state.

Leaf nodes 3 through n receive the MS (1, 1) request, switches traffic through the protection tree in operation 1124, and transmits NR (1, 1) to the root node as a response in operation 1125.

In operation 1118, when Leaf nodes 2 receives the MS (1, 1) request set to the P flag from the root node, Leaf nodes 2 determines that the root node accepts a request from another leaf node, and withdraws the MS-W command directed to Leaf node 2. Leaf node 2 transmits an NR (1, 1) message to the root node, and the root node receives NR (1, 1) message in operation 1119.

In operations 1110, 1120, and 1126, the root node includes the MS (1, 1) request in the NR (1, 1) message, and transmits the NR (1, 1) message—to all of the leaf nodes.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of operating a root node, the method comprising:
receiving, from a first leaf node, a message indicating an occurrence of a failure on a path of the first leaf node from among a plurality of leaf nodes that transmits/receives traffic;
recognizing an occurrence of a local failure on the path of the first leaf node; and
transmitting information about the failure to the plurality of leaf nodes.

2. The method of claim 1, further comprising:
transmitting/receiving traffic by switching a working path to a protection path.

3. The method of claim 1, further comprising:
transmitting a first no request (NR) message to the plurality of leaf nodes; and
receiving a second NR message from the plurality of leaf nodes.

4. The method of claim 1, wherein the transmitting of the information about the failure to the plurality of leaf nodes further comprises transmitting a second signal failure (SF) message indicating an occurrence of a failure on the first leaf node to the plurality of leaf nodes, and
the second SF message is a message that switches the plurality of leaf nodes to a protection path from a working path.

5. The method of claim 1, further comprising:
receiving a third NR message indicating a clearance of a failure from the first leaf node.

6. The method of claim 4, further comprising:
determining that the failure is cleared from the first leaf node; and
entering a wait to restore (WTR) state.

7. The method of claim 6, further comprising:
switching from the protection path to the working path.

8. The method of claim 6, further comprising:
transmitting a WTR message to the plurality of leaf nodes.

9. The method of claim 7, wherein the transmitting of the second SF message comprises transmitting the second SF message comprising information indicating that an occurrence of a failure in a root node is fake, and
the transmitting of the WTR message comprises transmitting the WTR message comprising information indicating a clearance of a failure in a root node is fake.

10. The method of claim 7, further comprising:
transmitting the WTR message and initiating a WTR timer; and
transmitting a fourth NR message to the plurality of leaf nodes when the WTR timer is suspended.

11. The method of claim 10, wherein the fourth NR message is a message that switches the plurality of leaf nodes to a working path from a protection path.

12. The method of claim 6, further comprising:
maintaining transmitting/receiving of the traffic to the protection path.

13. The method of claim 12, further comprising:
transmitting the WTR message and initiating a WTR timer; and
transmitting a do not revert (DNR) message to the plurality of leaf nodes when the WTR timer is suspended.

14. The method of claim 13, wherein the DNR message is a message that indicates a clearance of a failure from the first node.

15. The method of claim 1, further comprising:
receiving a request comprising a priority from the plurality of leaf nodes.

16. The method of claim 15, further comprising:
processing the request from the plurality of leaf nodes based on the priority.

17. A method of operating a leaf node, the method comprising:
detecting an occurrence of a failure on a working path for transmitting/receiving a root node and traffic;
transmitting a first SF message indicating the occurrence of the failure on the working path;
receiving a second SF message indicating the occurrence of the failure on the working path; and
transmitting/receiving traffic by switching the working path to a protection path.

18. The method of claim 17, further comprising:
detecting that a clearance of the failure; and
transmitting, to the root node, a third NR message indicating the clearance of the failure.

19. The method of claim 17, further comprising:
receiving a WTR message from the root node;
receiving a fourth NR message indicating the clearance of the failure; and
switching the protection path to the working path.

20. The method of claim 17, further comprising:
receiving a DNR message from the root node;
receiving the fourth NR message indicating the clearance of the failure; and
maintaining transmitting/receiving of traffic to the protection path.
